(19) United States
(12) Patent Application Publication
(10) Pub. No.: US 2018/0190954 A1
(43) Pub. Date: Jul. 5, 2018

(54) POWER SUPPLY DEVICE, AND VEHICLE EQUIPPED WITH SAME

(71) Applicant: SANYO Electric Co., Ltd., Osaka (JP)

(72) Inventors: HIROYUKI HASHIMOTO, Hyogo (JP); KAZUNARI HIRAIDE, Osaka (JP); TAKAYUKI HATTORI, Hyogo (JP)

(21) Appl. No.: 15/527,888

(22) PCT Filed: Oct. 2, 2015
(86) PCT No.: PCT/JP2015/005033

§ 371 Date: May 18, 2017

(30) Foreign Application Priority Data
Feb. 27, 2015 (JP) 2015-039370

(51) Int. Cl. H01M 2/10; H01M 2/12; H01M 2/34

(52) U.S. Cl. CPC H01M 2/1077; H01M 2/1229; H01M 2200/00; H01M 2/34; H01M 2220/20; H01M 2/1094

(57) ABSTRACT

Each secondary battery cell includes: an exterior can that has a rectangular outer shape having a thickness smaller than the width and has an open upper surface; a sealing plate for blocking the opening of the exterior can; a pair of electrode terminals disposed on the sealing plate; a conductive reversing plate that is disposed on the sealing plate, and becomes deformed when the internal pressure of secondary battery cell becomes a predetermined value or more; and connection plate that is disposed on the sealing plate and on the outer surface side of secondary battery cell, and, when the reversing plate becomes deformed, contacts and electrically connects to the reversing plate to block an external output. Fastening member is disposed on the upper surface of the cell stacked body so as to overlap the position at which the reversing plate is disposed on the upper surface of the sealing plate of each secondary battery cell.

### TECHNICAL FIELD

The present invention relates to a power supply device and a vehicle equipped with the power supply device, for example relates to a power supply device of a motor that is mounted in an electric vehicle such as a hybrid car, a fuel-cell car, an electric car, or an electric motorcycle and makes the vehicle travel.

### BACKGROUND ART

In a power supply device for a vehicle, in order to increase the power supplied to a motor for making the vehicle travel, a battery block is formed by interconnecting many chargeable secondary battery cells in series, and the output voltage of the battery block is increased. This power supply device is discharged by supplying the power to the motor in the travel state of the vehicle, and is charged by a power generator during the regenerative braking of the vehicle. The discharging current of the battery defines the driving torque of the motor, and the charging current of the battery defines the braking force for performing the regenerative braking. Therefore, in order to increase the driving torque of the motor for accelerating the vehicle, the discharging current of the battery must be increased. Furthermore, in order to increase the regenerative braking of the vehicle, the battery must be charged at a high current.

A power supply device used for such an application can go into an overcharge state. In the overcharge state, the internal pressure of the battery can become abnormally high, and hence a battery including a pressure-sensitive safety mechanism has been developed. For example, a typical secondary battery cell includes a gas exhaust valve in a sealing plate for sealing an exterior can in which a power generation element is enclosed. When the internal pressure in the exterior can increases, the gas exhaust valve opens to exhaust the gas from the exterior can, and can decrease the internal pressure.

While, recently, in order to improve the safety, not only the structure of the gas exhaust valve, but also a configuration including a safety mechanism having different structures has been disclosed (Patent Literature 1). The power supply device of Patent Literature 1 includes a plurality of secondary battery cells having a current breaking mechanism as the safety mechanism. The current breaking mechanism is disposed on a conduction path that connects an output terminal of a secondary battery cell to a power generation element in the exterior can. The current breaking mechanism includes a conductive member that becomes deformed in response to the internal pressure of the secondary battery cell. When the internal pressure of the secondary battery cell becomes higher than a set pressure, the conductive member becomes deformed and the conduction between the output terminal and the power generation element can be blocked.

As the above-mentioned safety mechanism, a secondary battery cell that includes a function of forcibly short-circuiting the battery and a fuse function of thermally fusing the battery has been also disclosed (Patent Literature 2). The secondary battery cell of Patent Literature 2 includes a fuse portion on a conduction path that connects an output terminal to a power generation element in an exterior can. As shown in FIG. 20, the secondary battery cell includes connection plate 163 connected to the output terminal and reversing plates 161 and 162 that become deformed in response to the internal pressure of the exterior can. The reversing plates are conducted to the exterior can. By bringing the reversing plates into contact with connection plate 163, the positive and negative output terminals of the secondary battery cell can be short-circuited via the exterior can. When the positive and negative output terminals of the secondary battery cell are short-circuited, a high current flows also through the fuse portion, and the fuse portion is activated to block the output from the secondary battery cell.

### CITATION LIST

### Patent Literature

PTL 1: Unexamined Japanese Patent Publication No. 2010-157451

PTL 2: Unexamined Japanese Patent Publication No. 2012-195278

### SUMMARY OF THE INVENTION

### Technical Problem(s)

As discussed above, a pressure-sensitive safety mechanism is widely employed as a safety mechanism for preventing the increase in the internal pressure of secondary battery cells. While, regarding the pressure-sensitive safety mechanism, it is difficult to design the working pressure at which the safety mechanism operates. When the sealing plate of the secondary battery cell becomes deformed, there is a possibility that the safety mechanism does not operate at a set working pressure. Especially, the sealing plate is fixed to an opening end of the exterior can by adhesion or welding, so that the constraint structure is relatively weak. Therefore, there is a possibility that the sealing plate becomes deformed while the secondary battery cells repeat expansion and contraction. In the case that the power supply device is used for an automobile, a torsional stress can be applied to the power supply device due to vibration or impact, and degradation of the exterior can and sealing plate also causes the deformation. When the sealing plate becomes deformed due to these factors, this deformation can disturb a normal operation of the pressure-sensitive safety mechanisms of some secondary battery cells.

The present invention addresses these disadvantages of the conventional power supply devices. One of the objectives of the present invention is to provide a power supply device that stably operates a pressure-sensitive safety mechanism by suppressing the deformation of a sealing plate, and provide a vehicle equipped with the power supply device.

### Solution(s) to Problem(s) and Advantageous Effect(s) of Invention

In order to achieve the objective, a power supply device in accordance with a first aspect of the present invention is provided. The power supply device includes: a cell stacked body formed by stacking a plurality of secondary battery cells; and a fastening member for fastening the cell stacked body. Each secondary battery cell includes: an exterior can that has a rectangular outer shape having a thickness smaller than the width, and has an open upper surface; a sealing plate for blocking the opening in the exterior can; a pair of electrode terminals disposed on the sealing plate and on the outer surface side of the secondary battery cell; and a conductive reversing plate that is disposed on the sealing plate and on the inner surface side of the secondary battery cell, and becomes deformed when the internal pressure of the secondary battery cell becomes a predetermined value or more. The fastening member can be disposed on the upper surface of the cell stacked body so as to overlap the position at which the reversing plate is disposed on the upper surface of the sealing plate of each secondary battery cell. In the above-mentioned configuration, the fastening member for fastening the cell stacked body can prevent the sealing plate of each secondary battery cell from becoming deformed, and allows the reversing plate to stably operate.

A power supply device in accordance with a second aspect further includes a connection plate that is disposed on the sealing plate and on the outer surface side of the secondary battery cell, and, when the reversing plate becomes deformed, comes into contact with and electrically connects to the reversing plate to block an external output from the secondary battery cell.

In a power supply device in accordance with a third aspect, the fastening member can be disposed on the upper surface of the cell stacked body so as to come into contact with the sealing plates. This configuration improves the protecting effect of the sealing plates by the fastening member.

In a power supply device in accordance with a fourth aspect, the fastening member can be disposed on the upper surfaces of the connection plates. In this configuration, regions having the connection plates constituting the safety mechanisms are protected by the fastening member, and a stable operation of the safety mechanisms is allowed.

In a power supply device in accordance with a fifth aspect, the fastening members can be disposed at a plurality of places on the upper surface of the cell stacked body, respectively. This configuration can increase the mechanical strength of the fastening by the fastening members.

In a power supply device in accordance with a sixth aspect, each secondary battery cell includes a gas exhaust valve in the sealing plate. When the internal pressure in the exterior can becomes a predetermined value or more, the gas exhaust valve opens to exhaust the internal gas. The fastening member is disposed at a position overlapping the gas exhaust valves in the plan view of the cell stacked body, and a space through which the gas exhaust valve communicates with the outside can be disposed.

In a power supply device in accordance with a seventh aspect, the gas exhaust valve can be disposed in the center in the longitudinal direction of each sealing plate. In this configuration, even when the secondary battery cells are stacked in the reversed state, the gas exhaust valve can be always disposed in the center of each sealing plate.

In a power supply device in accordance with an eighth aspect, the fastening member can be formed so as to be wider than the gas exhaust valves.

In a power supply device in accordance with a ninth aspect, the fastening member can include fastening openings at positions corresponding to the gas exhaust valves.

In a power supply device in accordance with a tenth aspect, the connection plate can be disposed at a position corresponding to the reversing plate on the upper surface of each sealing plate.

In a power supply device in accordance with an eleventh aspect, the connection plate can be connected to one of the electrode terminals.

Furthermore, a vehicle in accordance with a twelfth aspect can include a vehicle equipped with the above-mentioned power supply device.

### BRIEF DESCRIPTION OF DRAWINGS

FIG. 1 is an exploded perspective view of a power supply device in accordance with a first exemplary embodiment of the present invention.

FIG. 2 is a perspective view showing a cell assembly when an exterior case is removed from the power supply device of FIG. 1.

FIG. 3 is an exploded perspective view of the cell assembly of FIG. 2.

FIG. 4 is a plan view of the cell assembly of FIG. 2.

FIG. 5 is a schematic sectional view of the cell assembly of FIG. 2.

FIG. 6 is a schematic sectional view of a cell assembly in accordance with a second exemplary embodiment of the present invention.

FIG. 7 is a plan view of the cell assembly of FIG. 6.

FIG. 8 is a schematic sectional view of a cell assembly in accordance with a third exemplary embodiment of the present invention.

FIG. 9 is a schematic sectional view of a cell assembly in accordance with a fourth exemplary embodiment of the present invention.

FIG. 10 is a plan view of a cell assembly in accordance with a fifth exemplary embodiment of the present invention.

FIG. 11 is a schematic sectional view of the cell assembly of FIG. 10.

FIG. 12 is a plan view of a cell assembly in accordance with a sixth exemplary embodiment of the present invention.

FIG. 13 is a schematic sectional view of the cell assembly of FIG. 12.

FIG. 14 is a plan view of a cell assembly in accordance with a modified example.

FIG. 15 is a perspective view showing a fastening member of FIG. 14.

FIG. 16 is a schematic sectional view of a cell assembly in accordance with a seventh exemplary embodiment of the present invention.

FIG. 17 is an enlarged perspective view showing a gas opening of a secondary battery cell in accordance with the modified example.

FIG. 18 is a block diagram showing an example in which a power supply device is mounted in a hybrid car traveling by both an engine and a motor.

FIG. 19 is a block diagram showing an example in which a power supply device is mounted in an electric car traveling only by a motor.

FIG. 20 is a schematic sectional view showing a heat fuse structure of a conventional battery cell.

FIG. 21 is a sectional view showing a state in which a reversing plate of FIG. 20 comes into contact with a connection plate.

FIG. 22 is a sectional view showing another state in which the reversing plate of FIG. 20 comes into contact with the connection plate.

### DESCRIPTION OF EMBODIMENTS

### First Exemplary Embodiment

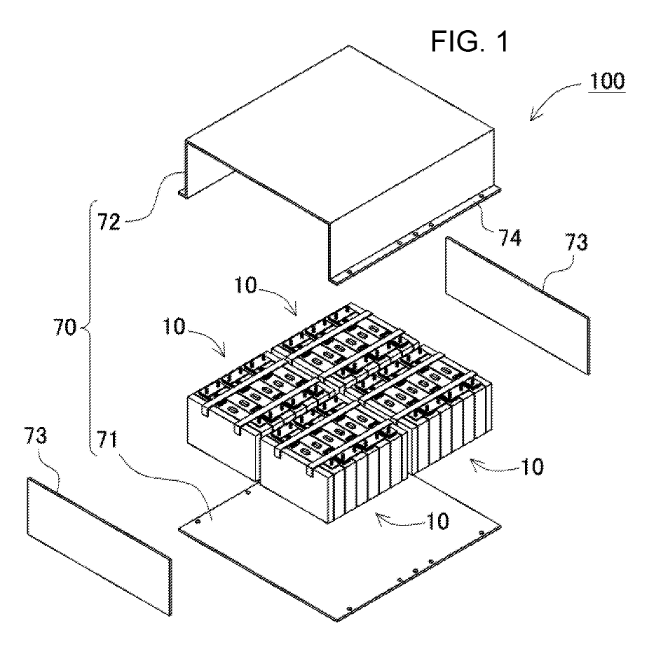

FIG. 1 to FIG. 5 show power supply device 100 in accordance with a first exemplary embodiment of the present invention. Power supply device 100 shown in these drawings shows an example of an on-vehicle power supply device. Specifically, power supply device 100 is mounted mainly in an electric vehicle such as a hybrid car or an electric car, and is used as a power source that supplies power to a travel motor of the vehicle and makes the vehicle travel. The power supply device of the present invention can be also used for an electric vehicle other than the hybrid car and electric car, and can be also used for an application, other than the electric vehicle, requiring a high power.

### (Power Supply Device 100)

As shown in the exploded perspective view of FIG. 1, the appearance of power supply device 100 has a box shape having a rectangular upper surface. In power supply device 100, exterior case 70 having a box shape is divided into two, and a plurality of cell assemblies 10 are stored in it. Exterior case 70 includes lower case 71, upper case 72, and end-surface plates 73 connected to the opposite ends of each of lower case 71 and upper case 72. End-surface plates 73 are connected to the opposite ends of each of lower case 71 and upper case 72, and block the opposite ends of exterior case 70. Upper case 72 includes collar portions 74 projecting outward, and is fixed to lower case 71 with nuts and bolts inserted into screw holes formed in collar portions 74. The screw holes in collar portions 74 can be used for fixing power supply device 100. For example, power supply device 100 is screwed and fixed to a vehicle using the screw holes.

Each cell assembly 10 is fixed to a fixed position inside exterior case 70. In the example of FIG. 1, a total of four cell assemblies 10, namely two rows in the longitudinal direction and two columns in the lateral direction, are stored on lower case 71. However, the number and layout of cell assemblies are not limited to this example. For example, one cell assembly may be stored in the exterior case.

### (Cell Assembly 10)

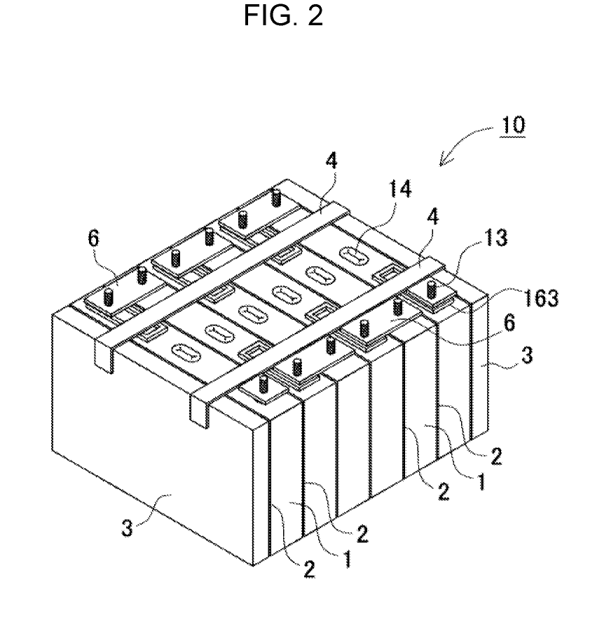

As shown in FIG. 2 to FIG. 4, each cell assembly 10 includes the following components:

a plurality of secondary battery cells 1;

separators 2 that are interposed between main surfaces of the plurality of stacked secondary battery cells 1 and isolate secondary battery cells 1 from each other;

a pair of end plates 3 disposed on end surfaces in the stacking direction of cell stacked body 5 that is formed by alternately stacking the plurality of secondary battery cells 1 and separators 2; and a plurality of metal-made fastening members 4 that are disposed on the upper surface of cell stacked body 5 and fasten end plates 3 to each other. Furthermore, cell assemblies 10 are fixed on lower case 71. For example, the bottom surfaces of secondary battery cells 1 are fixed to lower case 71 by adhesion using an adhesive or a pressure-sensitive adhesive sheet. Alternatively, the fastening members may be disposed on the bottom surface of the cell stacked body.

Lower case 71 also serves as a cooling plate for cooling cell stacked bodies 5. In other words, by thermally bonding the bottom surface of each secondary battery cell 1 to lower case 71, the heat generation of secondary battery cell 1 is thermally conducted to lower case 71 to promote the heat dissipation. A cooling pipe for internally circulating a refrigerant may be disposed on the lower surface of lower case 71.

### (Cell Stacked Body 5)

In each cell assembly 10, cell stacked body 5 is formed by stacking a plurality of secondary battery cells 1 via insulating separators 2, and a pair of end plates 3 are disposed on the opposite end surfaces of cell stacked body 5. End plates 3 are interconnected via fastening members 4. In cell assembly 10 in this drawing, separators 2 for insulating adjacent secondary battery cells 1 from each other are interposed between the stacking surfaces of secondary battery cells 1. Cell stacked body 5 is formed by alternately stacking a plurality of secondary battery cells 1 and separators 2.

In the cell assembly, it is not always necessary that the separators are interposed between the secondary battery cells. The requirement of separators can be eliminated by insulating adjacent secondary battery cells from each other in the following method, for example:

the exterior can of each secondary battery cell is molded of an insulating material such as resin; or

the outer periphery of the exterior can of each secondary battery cell is coated with a heat shrinkable tube, an insulating sheet, or an insulating paint. The separators do not always need to be interposed between the secondary battery cells, especially in the configuration that does not employ an air cooling method of cooling the secondary battery cells by forcibly blowing the cooling air between the secondary battery cells, but employs a method of cooling the cell stacked body via a cooling pipe having been cooled by a refrigerant or the like.

### (Secondary Battery Cells 1)

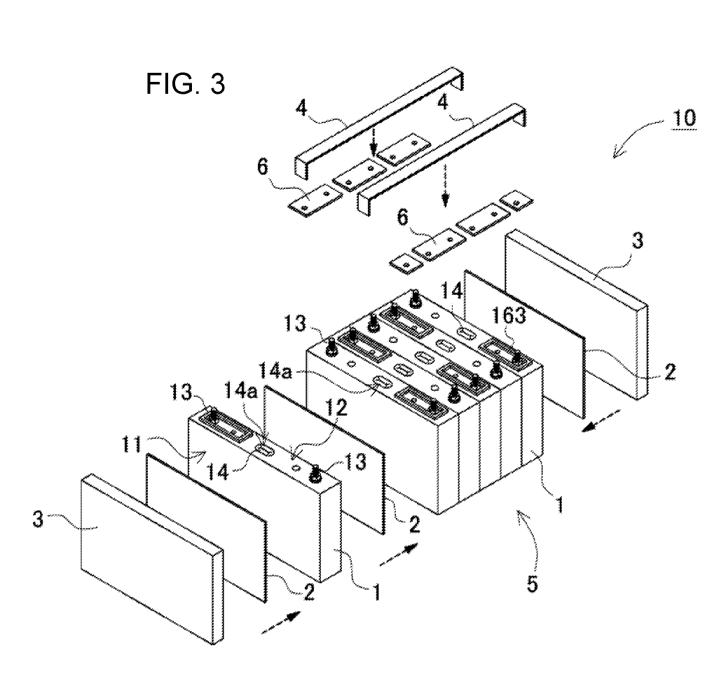

As shown in FIG. 3 or the like, exterior can 11 defining the outer shape of each secondary battery cell 1 has a rectangular shape, and its thickness is smaller than its width. Exterior can 11 is formed in a bottomed cylindrical shape whose upside is open, and the opening is blocked by sealing plate 12. As shown in the sectional view of FIG. 5 or the like, electrode assembly 15 is stored in exterior can 11. Sealing plate 12 includes positive and negative electrode terminals 13, and gas exhaust valve 14 disposed between electrode terminals 13. Gas exhaust valve 14 is configured so that, when the internal pressure of exterior can 11 increases to a predetermined value or more, gas exhaust valve 14 opens to exhaust the internal gas. The increase in internal pressure in exterior can 11 can be suppressed by opening gas exhaust valve 14. Preferably, gas exhaust valve 14 is disposed substantially in the center in the longitudinal direction of sealing plate 12. Thus, even when adjacent secondary battery cells 1 are stacked in the state where they are reverse to each other in the width direction, gas exhaust valves 14 can be always aligned to the centers of sealing plates 12. Each sealing plate 12 includes a reversing plate that becomes deformed when the internal pressure of secondary battery cell 1 becomes the predetermined value or more, and short-circuits the inside of secondary battery cell 1.

### (Short-Circuit Member 160)

In order to prevent overcharge or over discharge from causing a thermal runaway, each secondary battery cell 1 includes a safety mechanism that reacts with the increase in the internal pressure in exterior can 11 and blocks the output. Specifically, as shown in the sectional view of FIG. 5, each sealing plate 12 includes short-circuit member 160. First fuse portion 125 is disposed in an upper region of electrode assembly 15.

First fuse portion 125 includes first fuse hole 125a and first reinforcing projection 125b projected from the periphery of first fuse hole 125a. First fuse hole 125a serves as a fuse for blocking the current flow. The region including first fuse hole 125a is molten by the heat generated when a short circuit occurs in secondary battery cell 1 and a high current flows. By melting first connection portion 121 in the region including first fuse hole 125a in first fuse portion 125, secondary battery cell 1 is electrically separated. First reinforcing projection 125b has a strength reinforcing function of reinforcing the strength of the region having first fuse hole 125a so as to prevent the following accident: before a short circuit occurs in secondary battery cell 1, the region having first fuse hole 125a is cut by an external impact.

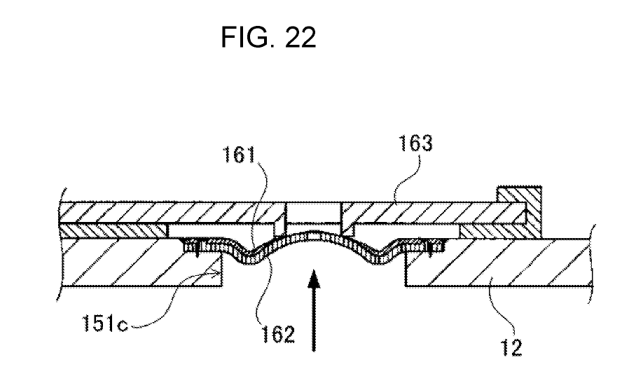

When the internal pressure in secondary battery cell 1 becomes higher than a critical pressure due to overcharge or the like, short-circuit member 160 causes a short circuit and serves so that first fuse portion 125 blocks the current flow. Short-circuit member 160 includes first reversing plate 161 made of an electrically conductive material, second reversing plate 162, and connection plate 163. First reversing plate 161 and second reversing plate 162 are disposed in the overlapping attitude in a normal and non-reversed state. Connection plate 163 is disposed on the upper surface of sealing plate 12, namely on the outer surface side of secondary battery cell 1, and disposed at a position corresponding to these reversing plates. Furthermore, connection plate 163 is electrically connected to one of electrode terminals 13. In this example, negative-side electrode terminal 13 is connected to connection plate 163. Specifically, for conduction, negative-side electrode terminal 13 is inserted into a hole formed in a part of connection plate 163. When the internal pressure of secondary battery cell 1 becomes the predetermined value or more, short-circuit member 160 blocks the external output in the following processes, as shown in FIG. 21 and FIG. 22:

first reversing plate 161 and second reversing plate 162 are pressed up by the internal pressure, and are deformed and reversed;

the reversed reversing plates come into contact with connection plate 163 to cause the conduction;

the inside of secondary battery cell 1 is short-circuited to generate a high current; and

a part of the short circuit is thermally molten.

Hereinafter, short-circuit member 160 is described in detail.

### (First Reversing Plate 161)

As shown in FIG. 5, first reversing plate 161 is disposed in short-circuit hole 151c in sealing plate 12 by a method such as welding. First reversing plate 161 is bent so as to project downward, and is electrically connected to sealing plate 12. When overcharge occurs in secondary battery cell 1 and the internal pressure of secondary battery cell 1 becomes higher than a first critical pressure, as shown in FIG. 21, first reversing plate 161 is reversed, is swelled upward, is projected, and comes into contact with connection plate 163, thereby causing a short circuit. In other words, first reversing plate 161 is projected in the separating direction from electrode assembly 15. When the short circuit is caused, a high current flows and heat is generated. At this time, first fuse portion 125 exhibits a fuse function to improve the safety of secondary battery cell 1.

### (Second Reversing Plate 162)

Second reversing plate 162 is disposed in short-circuit hole 151c in sealing plate 12 by a method such as welding, and is disposed under first reversing plate 161. Second reversing plate 162 is formed in a size substantially corresponding to first reversing plate 161, and overlaps first reversing plate 161. Second reversing plate 162 is also bent so as to project downward, and is electrically connected to sealing plate 12. When thin first reversing plate 161 is molten in a contact state with connection plate 163, as shown in FIG. 22, second reversing plate 162 is reversed, is swelled upward, is projected, and comes into contact with connection plate 163, thereby keeping the short circuit. In other words, even when first reversing plate 161 that has come into contact with connection plate 163 to cause the short circuit is molten by heat, second reversing plate 162 serves so as to keep the short circuit and continue the fuse function of first fuse portion 125. In this example, short-circuit member 160 includes two reversing plates, namely first reversing plate 161 and second reversing plate 162. However, short-circuit member 160 may include only one reversing plate.

A unit cell constituting secondary battery cell 1 is a chargeable secondary cell such as a lithium-ion secondary cell, a nickel-metal-hydride secondary cell, or a nickel-cadmium secondary cell. Especially, when a lithium-ion secondary cell is used as secondary battery cell 1, the charging capacity for the volume and mass of the whole secondary battery cell can be increased. Furthermore, the unit cell may be not only a secondary battery cell, but also a cylindrical battery cell or a laminated battery cell having a rectangular shape or another shape. Here, the laminated battery cell has an exterior body coated with a laminate material.

Secondary battery cells 1 that are stacked and constitute cell stacked body 5 are interconnected in series by connecting positive and negative electrode terminals 13 adjacent to each other via bus bar 6. Cell assembly 10 formed by interconnecting adjacent secondary battery cells 1 in series can achieve a high output voltage and a high power. However, the cell assembly may be formed by interconnecting the adjacent secondary battery cells in parallel, or in a combination of series connection and parallel connection.

### (Separator 2)

Each secondary battery cell 1 includes metal-made exterior can 11. In order to prevent secondary battery cell 1 from causing a short circuit to exterior can 11 of its adjacent secondary battery cell 1, insulating separator 2 is grasped between adjacent secondary battery cells 1. Separators 2 are spacers used for stacking secondary battery cells 1 so that adjacent secondary battery cells 1 are electrically and thermally insulated from each other. Each separator 2 is made of an insulating material such as plastic, is disposed between adjacent secondary battery cells 1, and insulates adjacent secondary battery cells 1 from each other.

### (End Plate 3)

A pair of end plates 3 are disposed on the opposite end surfaces of cell stacked body 5 that is formed by alternately stacking secondary battery cells 1 and separators 2, and end plates 3 fasten cell stacked body 5. Each end plate 3 is made of a material exhibiting a sufficient strength, for example a metal. End plate 3 includes a fixing structure for fixing end plate 3 to lower case 71 of FIG. 1. The end plate may be made of a resin, or the resin-made end plate may be reinforced by a member made of a metal.

### (Fastening Member 4)

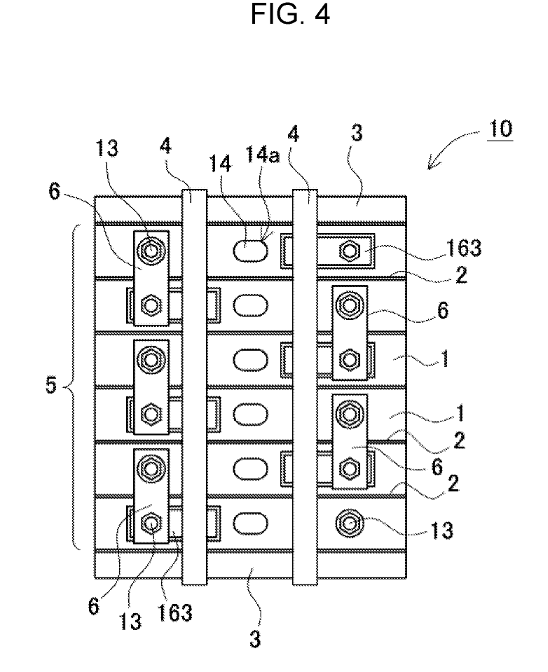

As shown in FIG. 3 and FIG. 4, fastening members 4 are disposed on the upper surface side of cell stacked body 5 having end plates 3 at its opposite ends, are fixed to the pair of end plates 3, and fasten cell stacked body 5. As shown in the exploded perspective view of FIG. 3, each fastening member 4 includes a body portion covering the upper surface of cell stacked body 5, and folded pieces that are formed by folding the opposite ends of the body portion and are fixed to end plates 3. Such fastening member 4 is made of a material having a sufficient strength, for example a metal. When a bind bar formed by folding a metal plate is used as fastening member 4, fastening member 4 can be produced inexpensively.

As shown in FIG. 4 and FIG. 5, fastening members 4 are disposed on the upper surface of cell stacked body 5 so as to overlap the positions having the reversing plates on the upper surfaces of sealing plates 12 of secondary battery cells 1. In this arrangement, fastening members 4 fasten cell stacked body 5, fastening members 4 cover and hold the upper surfaces of sealing plates 12 of secondary battery cells 1 to prevent cell stacked body 5 from coming deformed, and the reversing plates can be operated stably. Alternatively, fastening members 4 may be disposed at positions at which fastening members 4 do not overlap gas exhaust valves 14, thereby preventing fastening members 4 from disturbing the gas exhaustion when gas exhaust valves 14 are opened. Preferably, fastening members 4 are disposed on the upper surface of cell stacked body 5 so as to come into contact with sealing plates 12 or so as to approach sealing plates 12. Thus, the protecting effect of sealing plates 12 can be improved. Especially, as shown in the sectional view of FIG. 5, in the structure where connection plate 163 is disposed over the reversing plates, the reliability is expected to be improved for the following reasons:

by disposing fastening member 4 on the upper surface of connection plate 163, the reversing plates are positioned under fastening member 4; and

by strongly holding, with fastening member 4, the region in sealing plate 12 having the reversing plates, short-circuit member 160 including the reversing plates is stably operated against an external stress, especially against a stress such as torsion.

When secondary battery cells 1 are interconnected in series, as shown in the exploded perspective view of FIG. 3, secondary battery cells 1 are stacked in the state where the positive electrode of one of adjacent secondary battery cells 1 is close to the negative electrode of the other of adjacent secondary battery cells 1, namely in the state where secondary battery cells 1 are alternately in the reverse direction. Thus, bus bar 6 for interconnecting electrodes can be downsized. In this structure, the position of the reversing plate in one of adjacent secondary battery cells 1 is different from that in the other. As shown in the plan view of FIG. 4 and the sectional view of FIG. 5, therefore, two fastening members 4 are used, the arrangement positions of fastening members 4 on the upper surface of cell stacked body 5 are adjusted so that all of the reversing plates of secondary battery cells 1 overlap fastening members 4. Thus, all reversing plates are covered with fastening members 4, deformation of sealing plates 12 near the reversing plates is suppressed by fastening of fastening members 4, and a stable operation of the reversing plates is expected and the reliability is improved.

In the example of FIG. 5, one (left fastening member in the drawing) of two fastening members 4 presses the upper surfaces of connection plates 163. The other (right fastening member in the drawing) is disposed at a position covering the upper surfaces of plugs for blocking injection ports used for injecting an electrolytic solution into exterior cans 11. Thus, by covering the upper surfaces of the plugs with fastening member 4, unintended drop of the plugs can be avoided. Also in this time, by disposing projections on the contact surfaces of fastening member 4 so as to cover the plugs' collars that are projected from the surfaces of sealing plates 12, the plugs can be used for positioning fastening member 4.

The projections may be directly disposed on the lower surface of the fastening member. Alternatively, as shown in the sectional view of FIG. 5, spacer 20 may be interposed between fastening member 4 and sealing plate 12, and a projection may be disposed on the lower surface of spacer 20. Especially, when spacer 20 is made of an insulating material, fastening member 4 can be effectively insulated from the upper surface of exterior can 11 of each secondary battery cell 1.

In the example of FIG. 5, the structure where fastening members 4 are disposed at two places on the upper surface of cell stacked body 5 is provided. Thus, fastening members 4 are disposed in a plurality of places on the upper surface of cell stacked body 5. In the present invention, however, the fastening members do not always need to be disposed at positions overlapping the reversing plates. By tightening the fastening members on the upper surfaces of the sealing plates and fixing the sealing plates from the upside, a protection effect of preventing the deformation of the sealing plates is produced.

### Second Exemplary Embodiment

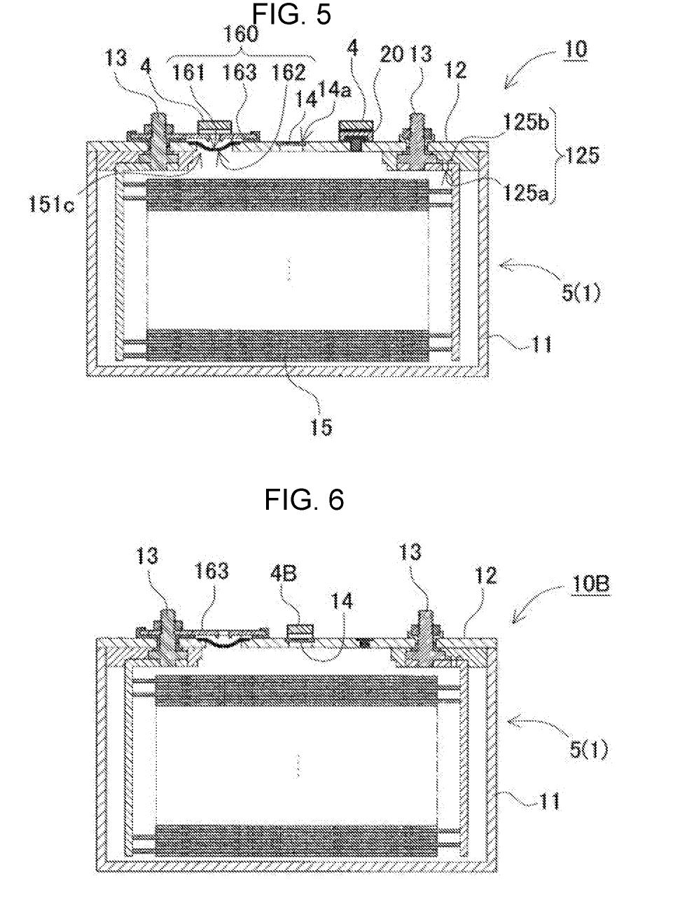

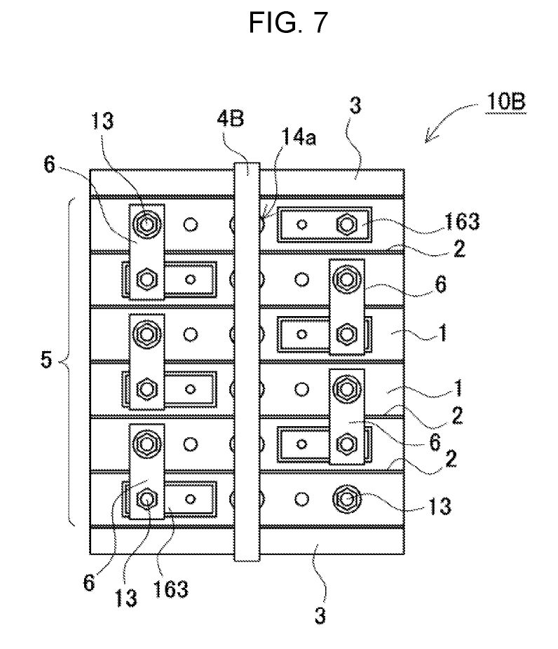

For example, as in cell assembly 10B of a second exemplary embodiment shown in the sectional view of FIG. 6 and the plan view of FIG. 7, fastening member 4B may be disposed near the centers of sealing plates 12. Thus, the cell stacked body may be fastened by not only a plurality of fastening members but also one fastening member.

### Third Exemplary Embodiment

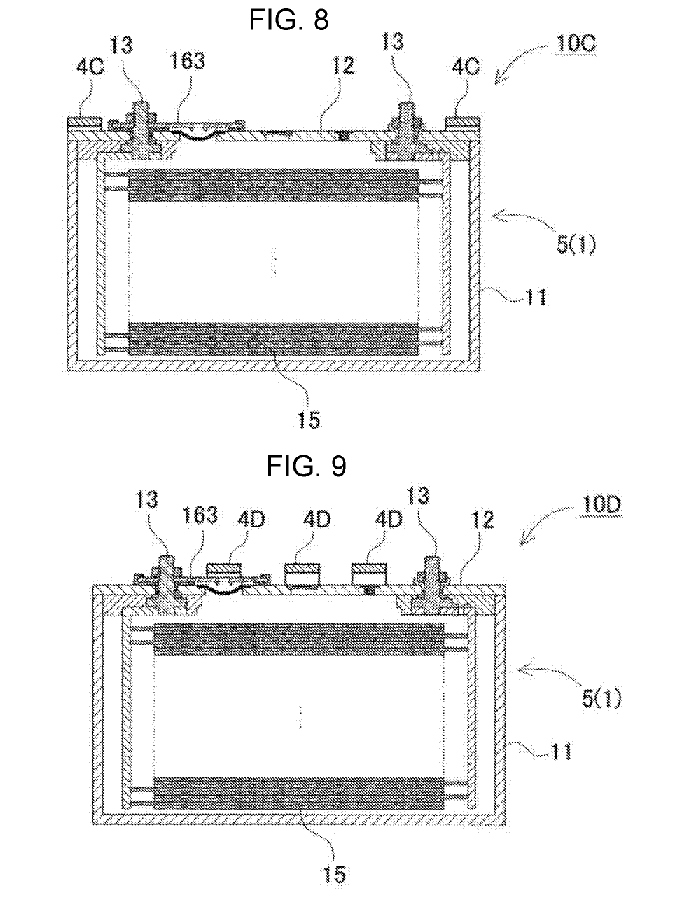

As in cell assembly 10C of a third exemplary embodiment shown in the sectional view of FIG. 8, the upper surfaces of the opposite lateral ends of sealing plates 12 are fastened by fastening members 4C.

### Fourth Exemplary Embodiment

The number of fastening members 4 may be three or more. For example, as in cell assembly 10D of a fourth exemplary embodiment shown in FIG. 9, fastening members 4D may be disposed in not only the right and left parts but also the center part.

### (Gas Exhaust Valve 14)

The operation of gas exhaust valves 14 in the cell assembly of the second exemplary embodiment shown in FIG. 6 is described. When fastening member 4B is disposed on the upper surface of cell stacked body 5, as shown in the plan view of FIG. 7, the width of fastening member 4B is made narrower than the lateral width of gas openings 14a so that fastening member 4B does not disturb the gas exhaust when gas exhaust valves 14 are opened. Thus, gas openings 14a are not completely blocked by fastening member 4B and are partially exposed, and hence gas can be exhausted when gas exhaust valves 14 are opened. When fastening member 4B is disposed on the upper surface of cell stacked body 5, preferably, it is disposed in the state where both ends of each gas opening 14a are exposed from fastening member 4B in the plan view. Thus, gas can be exhausted from both ends of fastening member 4B, and gas can be exhausted in a balanced manner.

### Fifth Exemplary Embodiment

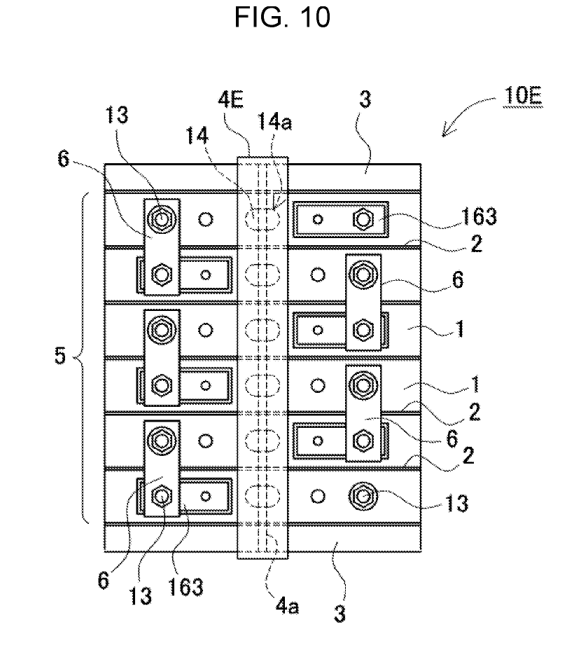

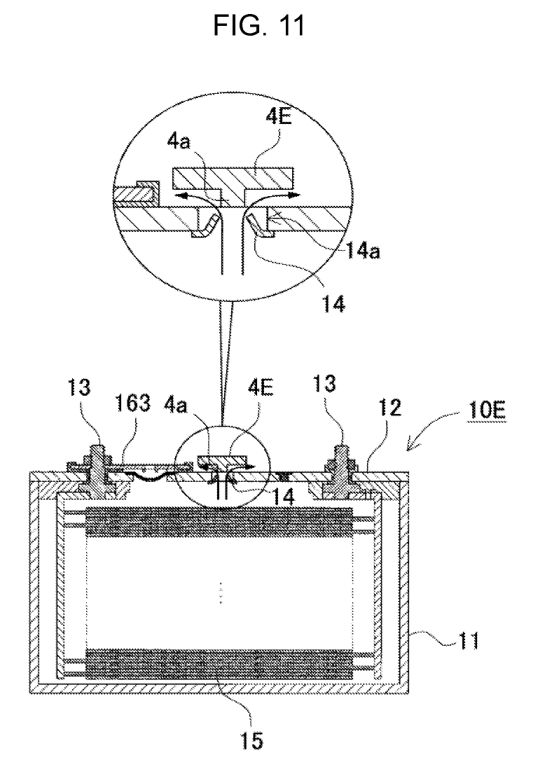

Alternatively, the mechanical strength can be improved by making the fastening member wide. In this case, when the width of the fastening member is wider than gas openings 14a of gas exhaust valves 14, a structure that does not disturb the gas exhaust operation of gas exhaust valves 14 during valve opening is required. For example, as in cell assembly 10E of a fifth exemplary embodiment shown in the plan view of FIG. 10 and the sectional view of FIG. 11, fastening member 4E has a T-shaped cross section, its lower surface facing cell stacked body 5 is formed as narrow ridge 4a, and the width of ridge 4a is made narrower than that of gas openings 14a. Thus, as shown in the sectional view of FIG. 11, gas openings 14a are exposed on both sides of ridge 4a, so that gas exhaust routes are formed when gas exhaust valves 14 are opened.

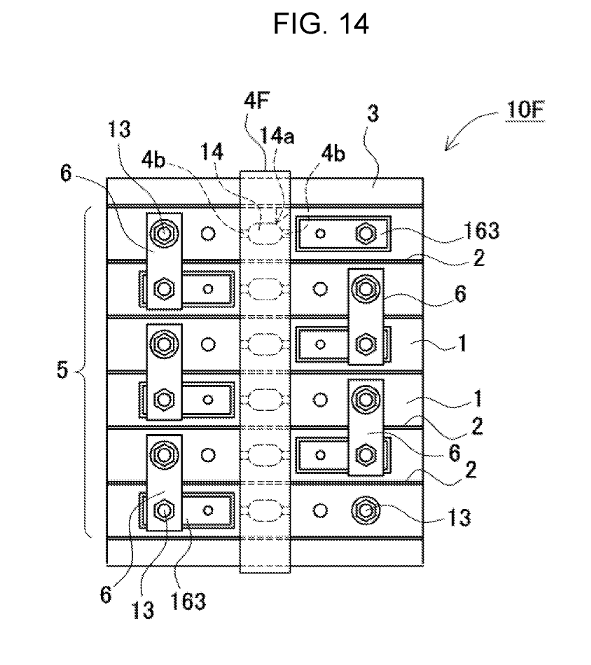

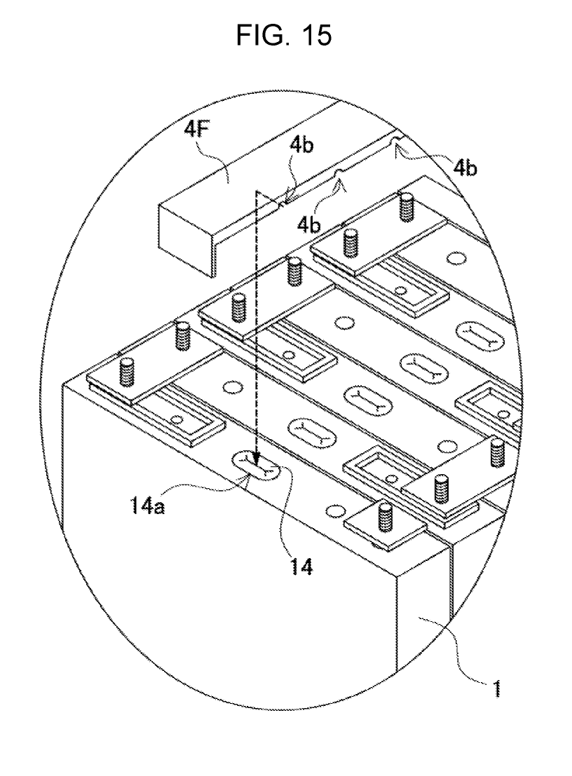

Alternatively, grooves for gas exhaust may be formed at the positions corresponding to the gas openings on the lower surface of the fastening member. For example, as in cell assembly 10F of a modified example shown in the plan view of FIG. 14 and the perspective view of FIG. 15, fastening member 4F is wider than gas openings 14a. Furthermore, the lower surface of fastening member 4F has grooves 4b, which communicate with its side surfaces, at the positions corresponding to gas openings 14a in the state where fastening member 4F is disposed on the upper surface of cell stacked body 5. Thus, fastening member 4 presses cell stacked body 5 in contact with its upper surface, and gas openings 14a communicate with the outside through grooves 4b. Therefore, gas can be exhausted to the outside via grooves 4b when gas exhaust valves 14 are opened.

### Sixth Exemplary Embodiment

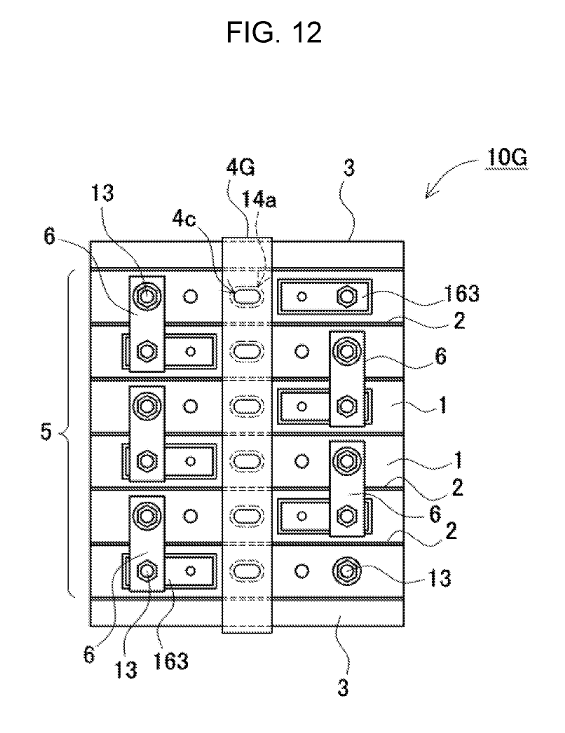

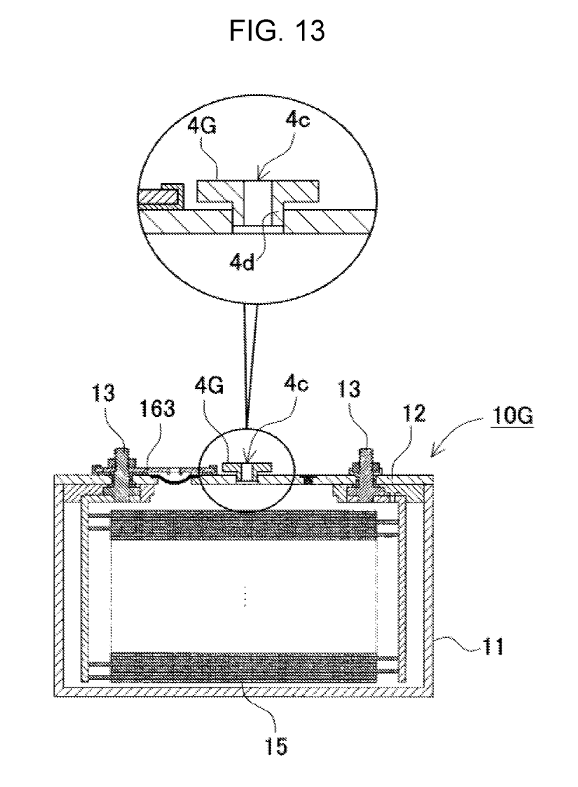

As another example, an opening for gas exhaust may be formed in a fastening member. For example, in cell assembly 10G of a sixth exemplary embodiment shown in the plan view of FIG. 12 and the sectional view of FIG. 13, fastening member 4G has fastening openings 4c at the positions corresponding to gas openings 14a in the state where fastening member 4G is disposed on the upper surface of cell stacked body 5. In this structure, when gas exhaust valves 14 are opened, gas can be certainly exhausted to the outside of external cans 11 via fastening openings 4c from gas openings 14a.

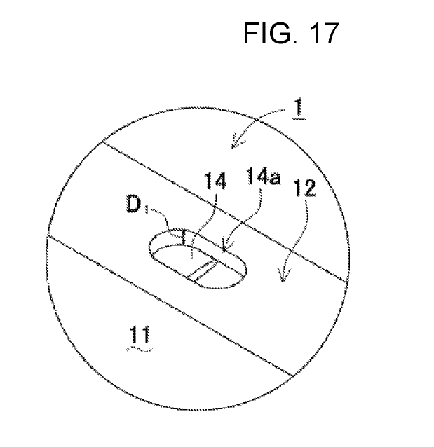

Each fastening opening 4c may include projection wall 4d projected downward along the opening edge. By inserting projection wall 4d into gas opening 14a, advantageously, gas opening 14a can be used for positioning fastening member 4. Especially, as shown in the enlarged perspective view of FIG. 17, in the structure where thickness D₁ of sealing plate 12 is relatively thick and gas exhaust valve 14 is disposed at a position deep by thickness D₁ from the surface of sealing plate 12, a space or stroke for storing projection wall 4d can be secured using the thickness of sealing plate 12 and the workability and positioning accuracy in assembling fastening member 4G can be improved.

### Seventh Exemplary Embodiment

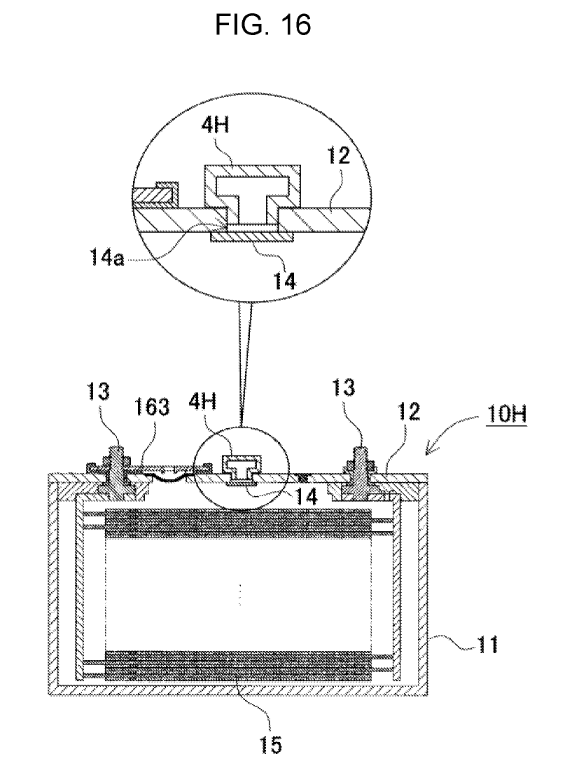

As in cell assembly 10H of a seventh exemplary embodiment shown in the sectional view of FIG. 16, fastening member 4H is made hollow, each gas exhaust valve 14 is made to communicate with the internal space, and the edge of the hollow fastening member can be connected to a duct. Thus, fastening member 4H can be used not only as the function of fastening cell stacked body 5 but also as a gas exhaust route. For example, by making the duct to communicate with the outside of the vehicle, a high-temperature and high-pressure gas can be safely guided and exhausted to the outside of the vehicle.

By disposing fastening member 4 on the upper surface side of cell stacked body 5 in the above-mentioned manner, each sealing plate 12 can be prevented from coming deformed, the operation of a reversing plate disposed in sealing plate 12 can be secured, and the reliability can be improved. By designing the arrangement position and shape of fastening member 4, the gas exhaust operation when gas exhaust valves 14 are opened can be secured.

The above-mentioned power supply devices can be used as on-vehicle power sources. An example of a vehicle equipped with a power supply device includes an electric vehicle, such as a hybrid car or plug-in hybrid car that travels by both an engine and a motor, or such as an electric car that travels only by a motor. The power supply devices are used as power sources for these vehicles.

### (Power Supply Device for Hybrid Car)

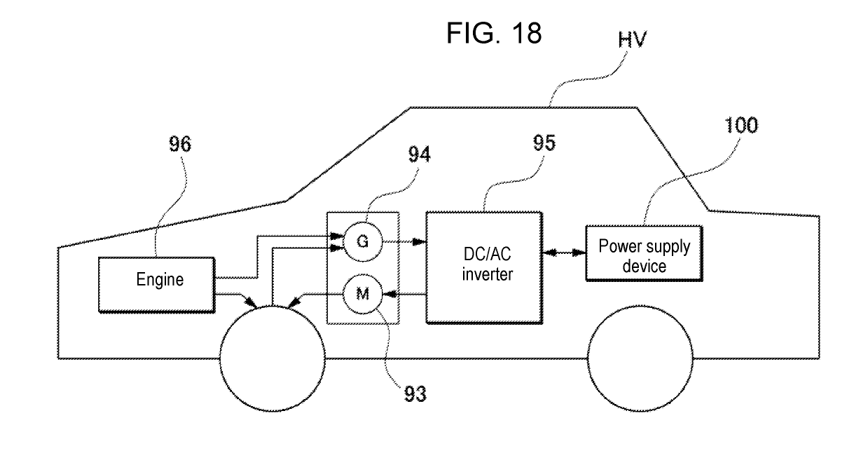

FIG. 18 shows an example in which a power supply device is mounted in a hybrid car traveling by both an engine and a motor. Vehicle HV equipped with a power supply device that is shown in this drawing includes: engine 96 and motor 93 for travel that make vehicle HV travel; power supply device 100 for supplying power to motor 93; and power generator 94 for charging the battery in power supply device 100. Power supply device 100 is connected to motor 93 and power generator 94 via direct current (DC)/alternating current (AC) inverter 95. Vehicle HV travels by both of motor 93 and engine 96 while charging and discharging the battery of power supply device 100. Motor 93 is driven when the engine efficiency is low, for example during acceleration or low-speed travel, and makes the vehicle travel. Motor 93 receives power from power supply device 100 and is driven. Power generator 94 is driven by engine 96 or is driven by regenerative braking when the vehicle is braked, and the battery of power supply device 100 is charged.

### (Power Supply Device for Electric Car)

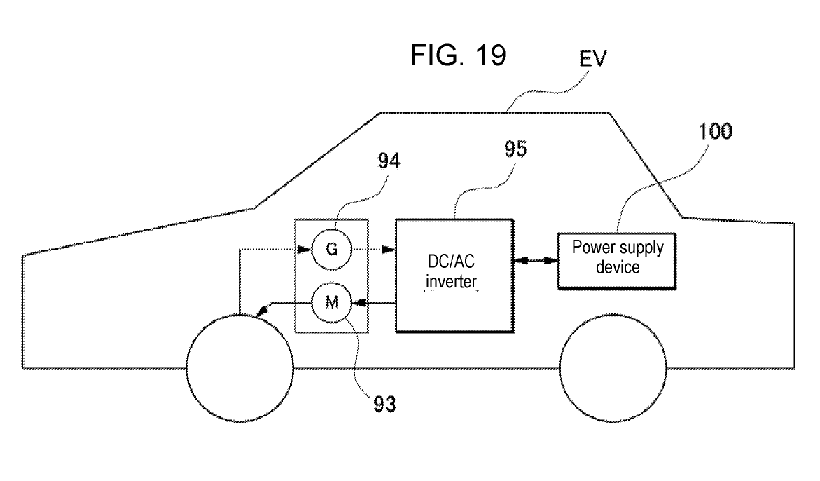

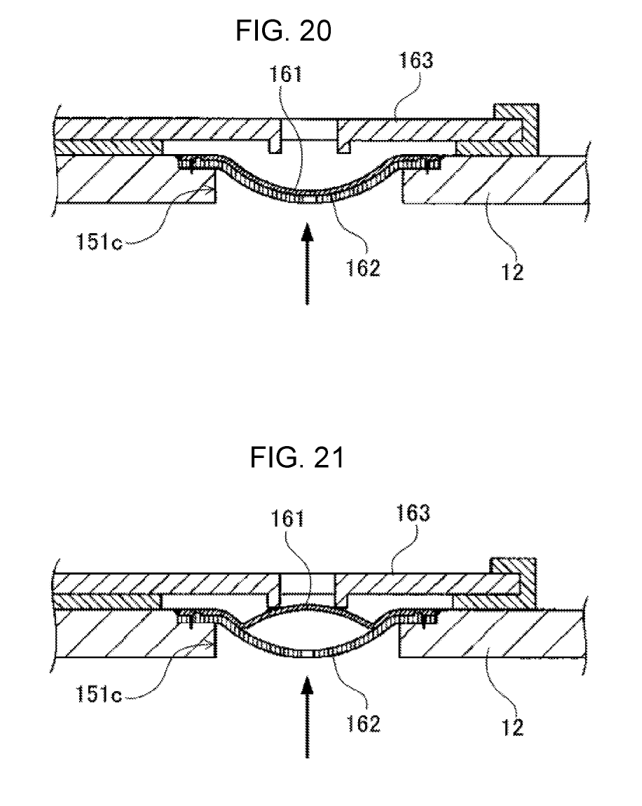

FIG. 19 shows an example in which a power supply device is mounted in an electric car traveling only by a motor. Vehicle EV equipped with a power supply device that is shown in this drawing includes: motor 93 for travel that makes vehicle EV travel; power supply device 100 for supplying power to motor 93; and power generator 94 for charging the battery in power supply device 100. Motor 93 receives power from power supply device 100 and is driven. Power generator 94 is driven by energy when regenerative braking is applied to vehicle EV, and the battery of power supply device 100 is charged.

Exemplary embodiments and examples of the present invention have been described with reference to the drawings. The exemplary embodiments and examples show devices for embodying the technical ideas of the present invention. The present invention is not limited to the above-mentioned devices. In the present description, members shown in the scope of claims are not limited to the members of the exemplary embodiments. Especially, the sizes, materials, and shapes of the components and relative arrangement between the components, which are described in the exemplary embodiments, do not limit the scope of the present invention but are simply explanation examples as long as there is no specific description. The sizes and the positional relation of the members in each drawing are sometimes exaggerated for clearing the explanation. Furthermore, in the above-mentioned explanation, the same names or the same reference marks denote the same members or same-material members, detailed description is appropriately omitted. Furthermore, regarding the elements constituting the present invention, a plurality of elements may be formed of the same member, and one member may serve as the plurality of elements. Conversely, the function of one member may be shared by the plurality of members.

### INDUSTRIAL APPLICABILITY

A power supply device and a vehicle equipped with the power supply device of the present invention can be suitably used as a power supply device for a plug-in hybrid electric car or hybrid electric car switchable between an electric-vehicle (EV) travel mode and a hybrid-electric-vehicle (HEV) travel mode, or an electric car. The power supply device can be appropriately used for the following applications: a backup power supply device mountable in a rack of a computer sever; a backup power supply device used for wireless base stations of mobile phones; a power source for storage used at home or in a factory; an electric storage device combined with a solar battery, such as a power source for street lights; and a backup power source for traffic lights.

### REFERENCE MARKS IN THE DRAWINGS

1 secondary battery cell
2 separator
3 end plate
4 fastening member
4B fastening member
4C fastening member
4D fastening member
4E fastening member
4F fastening member
4G fastening member
4H fastening member
4a ridge
4b groove
4c fastening opening
4d projection wall
5 cell stacked body
6 bus bar
10 cell assembly
10B cell assembly
10C cell assembly
10D cell assembly
10E cell assembly
10F cell assembly
10G cell assembly
10H cell assembly
11 exterior can
12 sealing plate
13 electrode terminal
14 gas exhaust valve
14a gas opening
15 electrode assembly
20 spacer
70 exterior case
71 lower case
72 upper case
73 end-surface plate
74 collar portion
93 motor
94 power generator
95 DC/AC inverter
96 engine
100 power supply device
125 first fuse portion
125a first fuse hole
125b first reinforcing projection
151c short-circuit hole
160 short-circuit member
161 first reversing plate
162 second reversing plate
163 connection plate
HV hybrid vehicle
EV electric vehicle

1. A power supply device comprising:
a cell stacked body formed by stacking a plurality of secondary battery cells; and
a fastening member for fastening the cell stacked body,
wherein each of the plurality of secondary battery cells includes:
an exterior can having a rectangular outer shape and an open upper surface, a thickness of the outer shape being smaller than a width of the outer shape;
a sealing plate for blocking an opening in the exterior can;
a pair of electrode terminals disposed on the sealing plate and on an outer surface side of each of the secondary battery cells; and
a conductive reversing plate disposed on the sealing plate and on an inner surface side of each of the secondary battery cells, and becoming deformed when an internal pressure of each of the secondary battery cells becomes a predetermined value or more, and
wherein the fastening member is disposed on an upper surface of the cell stacked body so as to overlap a position at which the reversing plate is disposed on an upper surface of the sealing plate of each of the plurality of secondary battery cells.

2. The power supply device according to claim 1, further comprising
a connection plate disposed on the sealing plate and on the outer surface side of each of the plurality of secondary battery cells, and, when the reversing plate becomes deformed, coming into contact with and electrically connecting to the reversing plate to block an external output from the corresponding secondary battery cell.

3. The power supply device according to claim 1, wherein
the fastening member is disposed on the upper surface of the cell stacked body so as to come into contact with the sealing plate.

4. The power supply device according to claim 1, wherein
the fastening member is disposed on an upper surface of the connection plate.

5. The power supply device according to claim 1, wherein
a plurality of the fastening members are disposed at a plurality of places on the upper surface of the cell stacked body, respectively.

6. The power supply device according to claim 1,
further comprising another fastening member for fastening the cell stacked body,
wherein
each of the plurality of secondary battery cells includes a gas exhaust valve in the sealing plate, and the gas exhaust valve opens to exhaust an internal gas when an internal pressure in the exterior can becomes a predetermined value or more, and
the another fastening member is disposed at a position overlapping the gas exhaust valve in a plan view of the cell stacked body, and has a space through which the gas exhaust valve communicates with an outside.

7. The power supply device according to claim 6, wherein
the gas exhaust valve is disposed in a center in a longitudinal direction of the sealing plate.

8. The power supply device according to claim 6, wherein
the another fastening member is formed so as to be wider than the gas exhaust valve.

9. The power supply device according to claim 8, wherein
the another fastening member includes a fastening opening at a position corresponding to the gas exhaust valve.

10. The power supply device according to claim 1, wherein
the connection plate is disposed at a position corresponding to the reversing plate on the upper surface of the sealing plate.

11. The power supply device according to claim 1, wherein
the connection plate is connected to one of the pair of electrode terminals.

12. A vehicle comprising
the power supply device according to claim 1.
